(19) United States
(12) Patent Application Publication
(10) Pub. No.: US 2017/0160855 A1
(43) Pub. Date: Jun. 8, 2017

(54) LIQUID CRYSTAL DISPLAY APPARATUS

(71) Applicant: WUHAN CHINA STAR OPTOELECTRONICS TECHNOLOGY CO. LTD., HUBEI (CN)

(72) Inventors: Gui CHEN, HUBEI (CN); Jingfeng XUE, HUBEI (CN)

(21) Appl. No.: 14/905,974

(22) PCT Filed: Dec. 24, 2015
(86) PCT No.: PCT/CN2015/098762

§ 371 Date: Jan. 19, 2016

(30) Foreign Application Priority Data
Dec. 3, 2015 (CN) 201510880918.4

(51) Int. Cl. G06F 3/041; G02F 1/1362; G02F 1/1368; G02F 1/133; G02F 1/1333

(52) U.S. Cl. CPC G06F 3/0416; G06F 3/0412; G02F 1/13306; G02F 1/13338; G02F 1/1368; G02F 1/136286; G02F 2202/104

(57) ABSTRACT

A liquid crystal display apparatus is provided, and includes a plurality of sensing units arranged in an array; a plurality of dummy lines, each of the dummy lines being disposed between two rows of the sensing units, wherein each of the dummy lines has a plurality of dummy line units, each of the dummy line units corresponds to one of the sensing units, and is electrically connected to the one of the sensing units.

### FIELD OF THE INVENTION

The present invention relates to the technical field of displays, and particularly to a liquid crystal touch display apparatus.

### BACKGROUND OF THE INVENTION

Low temperature poly-silicon thin film transistor liquid crystal displays (LTPS TFT-LCD) attract attention due to their high mobility and decent charging ability. However, the technique is complicated, and the manufacturing process control is extremely strict. In recent years, the LTPS-based in-Cell touch panels (In-cell TP) attract the public's and the designers' attention more and more. However, due to the great number of the dummy lines, the ports on the integrated circuits (IC) are very complicated, and the number of the ports is also many, greatly increasing the load of the ICs, and also increasing the complexity of the designs. Therefore, the optimization and simplification of the dummy lines are the technical goal which currently needs to be achieved.

FIG. 1 is a schematic structural diagram of a low temperature poly-silicon thin film transistor liquid crystal display in a prior art. In the sensing units 20 (also named touch sensing units or sensor pads), metal layers are generally used as metal lines. The dummy lines 30 are inserted between two adjacent sensing units, and are connected to the adjacent first sensing units 20 on the right side, that is, the dummy lines 30 are connected to the right adjacent sensing units 20, while the ends of the dummy lines 30, i.e., the ends of the dummy lines 30 distant from the integrated circuit (IC) are disconnected from the sensing units 20. The configuration of the dummy lines has the following defects: (1) Since the dummy lines are connected only to the first sensing units 20 adjacent to the IC, the resistance capacitance loading (RC Loading) of the first sensing units is greater than the other sensing units, thereby affecting the sensitivity of the first sensing units. (2) During the display function, the dummy lines 30 are connected to the common voltage of the driving signal (Vcom) to produce the effect of the anti-crosstalk of signal; however, during the display function, the dummy lines connected to the first sensing units 20 will interfere with the adjacent sensing units 20 thereto.

Therefore, it is necessary to provide a new technical solution to solve the technical problems.

### SUMMARY OF THE INVENTION

A primary object of the present invention is to provide a display apparatus for improving the touch sensitivity of the display apparatus.

To solve these problems, the technical solution of the present invention is as follows:

A liquid crystal display apparatus, comprising: a plurality of sensing units arranged in an array, formed by a transparent conductive material, and connected to a common voltage of a driving signal; and a plurality of dummy lines, each of the dummy lines being disposed between two rows of the sensing units, wherein each of the dummy lines has a plurality of dummy line units, and each of the dummy line units corresponds to one of the sensing units, and is electrically connected to the one of the sensing units.

In a further feature of an embodiment of the present invention, each of the dummy line units is electrically connected to an initial end, an intermediate section, and a last end of the one of the sensing units.

In a further feature of an embodiment of the present invention, each of the dummy line units is configured as an E-shaped structure, and electrically connected to an initial end, an intermediate section, and a last end of the one of the sensing units.

In a further feature of an embodiment of the present invention, the sensing units and the dummy lines are both formed by a transparent conductive material.

In a further feature of an embodiment of the present invention, during a display function, the dummy lines and the sensing units are both at the common voltage of the driving signal.

A liquid crystal display apparatus, comprising: a plurality of sensing units arranged in an array; and a plurality of dummy lines, each of the dummy lines being disposed between two rows of the sensing units, wherein each of the dummy lines has a plurality of dummy line units, and each of the dummy line units corresponds to one of the sensing units, and is electrically connected to the one of the sensing units.

In a further feature of an embodiment of the present invention, each of the dummy line units is electrically connected to an initial end, an intermediate section and a last end of the one of the sensing units.

In a further feature of an embodiment of the present invention, each of the dummy line units is configured as an E-shaped structure, and electrically connected to an initial end, an intermediate section and a last end of the one of the sensing units.

In a further feature of an embodiment of the present invention, the sensing units and the dummy lines are both formed by a transparent conductive material.

In a further feature of an embodiment of the present invention, the sensing units are formed by a transparent conductive material, and connected to a common voltage of a driving signal.

In a further feature of an embodiment of the present invention, during a display function, the dummy lines and the sensing units are both at the common voltage of the driving signal.

A liquid crystal display apparatus, comprising: a plurality of sensing units arranged in an array; and a plurality of dummy lines, each of the dummy lines being disposed between two rows of the sensing units, wherein each of the dummy lines has a plurality of dummy line units, and each of the dummy line units corresponds to one of the sensing units, and is electrically connected to an initial end, an intermediate section and a last end of the one of the sensing units.

In a further feature of an embodiment of the present invention, each of the dummy line units is configured as an E-shaped structure, and electrically connected to an initial end, an intermediate section and a last end of the one of the sensing units.

In a further feature of an embodiment of the present invention, the sensing units and the dummy lines are both formed by a transparent conductive material.

In a further feature of an embodiment of the present invention, the sensing units are formed by a transparent conductive material, and connected to a common voltage of a driving signal.

In a further feature of an embodiment of the present invention, during a display function, the dummy lines and the sensing units are both at the common voltage of the driving signal.

Compared with the configuration of conventional dummy lines as shown in FIG. 1, when the display apparatus of the present invention is in operation, the dummy lines are not lead by the first sensing units, but each of the dummy line units is lead by the corresponding sensing unit thereof, and therefore resistance capacitance loading (RC Loading) of each of the sensing unit is similar, thereby increasing the sensitivity of the sensing units. In addition, after the dummy lines are segmented into the dummy line units, each of the dummy line units respectively corresponds to and is connected to adjacent one of the sensing units, for reducing the signal interference of the dummy line units with the other sensing units during display, and maintaining the electric field uniformity of the entire panel, thereby effectively improving the touch sensitivity of the display apparatus.

### BRIEF DESCRIPTION OF THE DRAWINGS

The invention described herein, as examples only, is with reference to the accompanying drawings, wherein:

FIG. 1 is a schematic structural diagram of a low temperature poly-silicon thin film transistor liquid crystal display in a prior art;

FIG. 2 is a schematic structural diagram of a liquid crystal apparatus in accordance with a first embodiment of the present invention; and

FIG. 3 is a schematic structural diagram of a liquid crystal apparatus in accordance with a second embodiment of the present invention.

### DETAILED DESCRIPTION OF THE PREFERRED EMBODIMENTS

The term “embodiment” as used in this specification means serving as an example, implementation, or illustration. Furthermore, the articles “a” or “an” as used in the specification and the appended claims may generally be construed to mean “one or more” unless it is clearly specified to be the singular form in the context.

A liquid crystal display apparatus of the present invention may be a low temperature poly-silicon thin film transistor liquid crystal display (LTPS TFT-LCD).

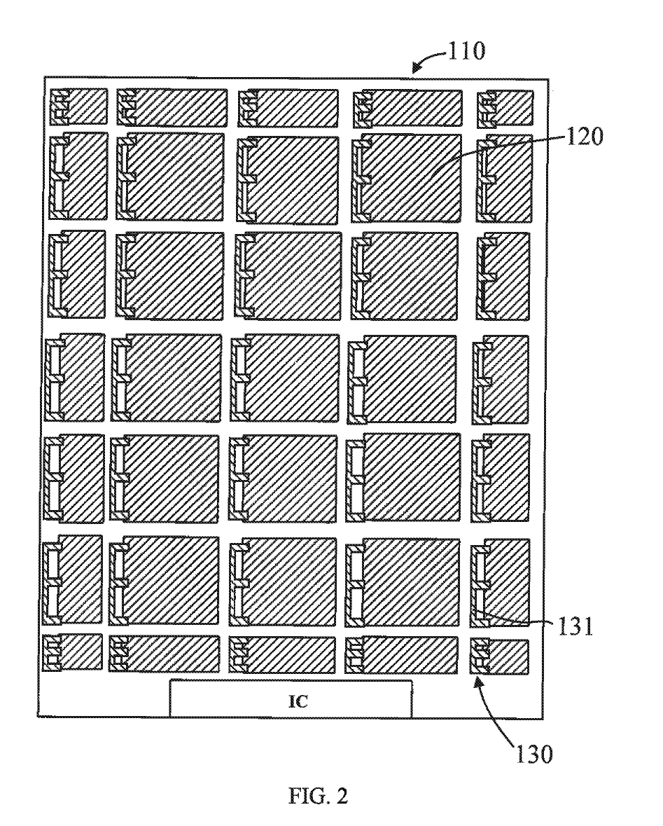

Please refer to FIG. 2, which is a schematic structural diagram of a liquid crystal apparatus in accordance with a first embodiment of the present invention.

A liquid crystal display apparatus 110 of the present embodiment includes a plurality of sensing units 120 and a plurality of dummy lines 130. The plurality of the sensing units 120 are arranged in an array. Each of the dummy lines 130 is disposed between two rows of the sensing units 120. Each of the dummy lines 130 is segmented into a plurality of dummy line units 131. Each of the dummy line units 131 corresponds to one of the sensing units 120, and is electrically connected to one right-adjacent sensing unit 120. Each of the dummy line units is configured as an E-shaped structure, and is electrically connected to an initial end, an intermediate section, and a last end of the one of the sensing units 120. The sensing units 120 and the dummy lines 130 are both formed by a transparent conductive material such as indium tin oxide (ITO). The sensing units are connected to a common voltage of a driving signal (Vcom). During the display function, the dummy lines 130 and the sensing units 120 are both at the common voltage of the driving signal.

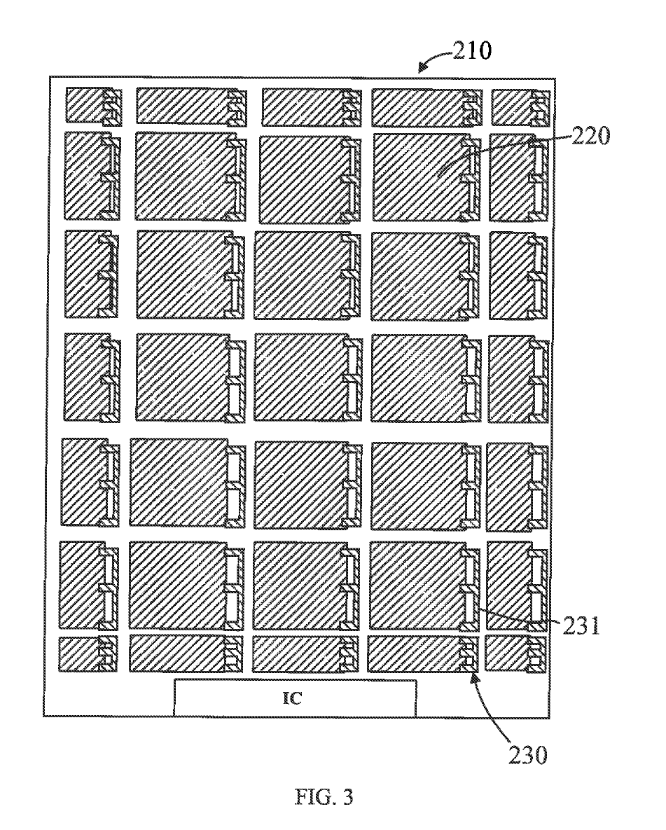

Moreover, another embodiment is also provided. Please refer to FIG. 3, which is a schematic structural diagram of a liquid crystal apparatus in accordance with a second embodiment of the present invention.

A liquid crystal display apparatus 210 of the present embodiment includes a plurality of sensing units 220 and a plurality of dummy lines 230. The plurality of the sensing units 220 are arranged in an array. Each of the dummy lines 230 is disposed between two rows of the sensing units 220. Each of the dummy lines 230 is segmented into a plurality of dummy line units 231. Each of the dummy line units 231 corresponds to one of the sensing units 220, and is electrically connected to one left-adjacent sensing unit 220. Each of the dummy line units is configured as an E-shaped structure, and is electrically connected to an initial end, an intermediate section and a last end of the one of the sensing units 220. The sensing units 220 and the dummy lines 230 are both formed by a transparent conductive material such as indium tin oxide (ITO). The sensing units are connected to a common voltage of a driving signal (Vcom). During the display function, the dummy lines 230 and the sensing units 220 are both at the common voltage of the driving signal. Hence, the sensing units 220 disposed on the left side of the dummy line units 231 also can achieve the touch display function as the first embodiment.

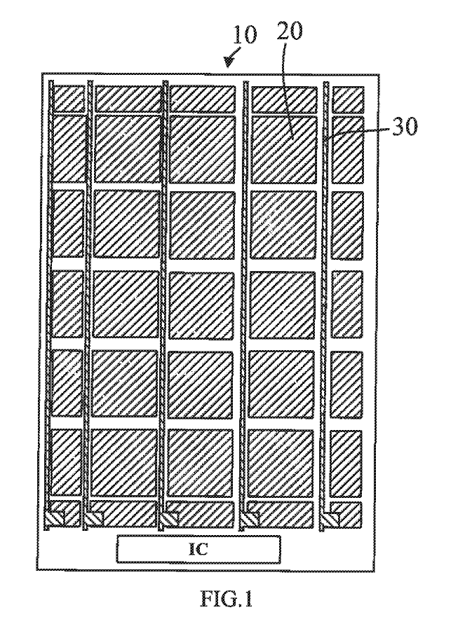

Compared with the configuration of conventional dummy lines as shown in FIG. 1, when the display apparatus of the present invention is in operation, the dummy lines are not lead by the first sensing units only, but each of the dummy line units is lead by the corresponding sensing unit thereof, and therefore resistance capacitance loading (RC Loading) of each of the sensing unit is similar, thereby increasing the sensitivity of the sensing units. In addition, after the dummy lines are segmented into the dummy line units, each of the dummy line units respectively corresponds to and is connected to adjacent one of the sensing units, for reducing the signal interference of the dummy line units with the other sensing units during display, and maintaining the electric field uniformity of the entire panel, thereby effectively improving the touch sensitivity of the display apparatus.

In summary, although the preferable embodiments of the present invention have been disclosed above, the embodiments are not intended to limit the present invention. A person of ordinary skill in the art, without departing from the spirit and scope of the present invention, can make various modifications and variations. Therefore, the scope of the invention is defined in the claims.

What is claimed is:

1. A liquid crystal display apparatus, comprising:
a plurality of sensing units arranged in an array, formed by a transparent conductive material, and connected to a common voltage of a driving signal; and
a plurality of dummy lines, each of the dummy lines being disposed between two rows of the sensing units, wherein each of the dummy lines has a plurality of dummy line units, and each of the dummy line units corresponds to one of the sensing units, and is electrically connected to the one of the sensing units.

2. The liquid crystal display apparatus as claimed in claim 1, wherein each of the dummy line units is electrically connected to an initial end, an intermediate section and a last end of the one of the sensing units.

3. The liquid crystal display apparatus as claimed in claim 2, wherein each of the dummy line units is configured as an E-shaped structure, and electrically connected to an initial end, an intermediate section and a last end of the one of the sensing units.

4. The liquid crystal display apparatus as claimed in claim 1, wherein the sensing units and the dummy lines are both formed by a transparent conductive material.

5. The liquid crystal display apparatus as claimed in claim 1, wherein during a display function, the dummy lines and the sensing units are both at the common voltage of the driving signal.

6. A liquid crystal display apparatus, comprising:
a plurality of sensing units arranged in an array; and
a plurality of dummy lines, each of the dummy lines being disposed between two rows of the sensing units, wherein each of the dummy lines has a plurality of dummy line units, and each of the dummy line units corresponds to one of the sensing units, and is electrically connected to the one of the sensing units.

7. The liquid crystal display apparatus as claimed in claim 6, wherein each of the dummy line units is electrically connected to an initial end, an intermediate section and a last end of the one of the sensing units.

8. The liquid crystal display apparatus as claimed in claim 7, wherein each of the dummy line units is configured as an E-shaped structure, and electrically connected to an initial end, an intermediate section and a last end of the one of the sensing units.

9. The liquid crystal display apparatus as claimed in claim 6, wherein the sensing units and the dummy lines are both formed by a transparent conductive material.

10. The liquid crystal display apparatus as claimed in claim 6, wherein the sensing units are formed by a transparent conductive material, and connected to a common voltage of a driving signal.

11. The liquid crystal display apparatus as claimed in claim 10, wherein during a display function, the dummy lines and the sensing units are both at the common voltage of the driving signal.

12. A liquid crystal display apparatus, comprising:
a plurality of sensing units arranged in an array; and
a plurality of dummy lines, each of the dummy lines being disposed between two rows of the sensing units, wherein each of the dummy lines has a plurality of dummy line units, and each of the dummy line units corresponds to one of the sensing units, and is electrically connected to an initial end, an intermediate section and a last end of the one of the sensing units.

13. The liquid crystal display apparatus as claimed in claim 12, wherein each of the dummy line units is configured as an E-shaped structure, and electrically connected to an initial end, an intermediate section and a last end of the one of the sensing units.

14. The liquid crystal display apparatus as claimed in claim 12, wherein the sensing units and the dummy lines are both formed by a transparent conductive material.

15. The liquid crystal display apparatus as claimed in claim 12, wherein the sensing units are formed by a transparent conductive material, and connected to a common voltage of a driving signal.

16. The liquid crystal display apparatus as claimed in claim 15, wherein during a display function, the dummy lines and the sensing units are both at the common voltage of the driving signal.
